(19) United States
(12) Patent Application Publication
(10) Pub. No.: US 2015/0381845 A1
(43) Pub. Date: Dec. 31, 2015

(54) APPARATUS AND METHOD OF OBTAINING IMAGE

(71) Applicant: ELECTRONICS AND TELECOMMUNICATIONS RESEARCH INSTITUTE, Daejeon (KR)

(72) Inventors: Jung Ho SONG, Daejeon (KR); Myoung Sook OH, Daejeon (KR); Ki Soo KIM, Seoul (KR); Bong Ki MHEEN, Daejeon (KR); Jae Sik SIM, Daejeon (KR); Yong Hwan KWON, Daejeon (KR); Min Hyup SONG, Daejeon (KR); Gyu Dong CHOI, Jeonju-si (KR)

(73) Assignee: ELECTRONICS AND TELECOMMUNICATIONS RESEARCH INSTITUTE, Daejeon (KR)

(21) Appl. No.: 14/620,226

(22) Filed: Feb. 12, 2015

(30) Foreign Application Priority Data
Jun. 25, 2014 (KR) 10-2014-0078431

(51) Int. Cl. H04N 1/028

(52) U.S. Cl. CPC H04N 1/02815

(57) ABSTRACT

Disclosed is an apparatus for obtaining an image. The apparatus for obtaining an image includes a light source, a scanner, a first beam splitter, and a light receiving unit. The light source generates a laser pulse. The scanner irradiates the laser pulse in a first direction. The first beam splitter splits the laser pulse irradiated in the first direction in the first direction and a second direction and irradiates the split laser pulse. The light receiving unit detects reflected light. Accordingly, it is possible to irradiate light to a wide range by a light source having a relatively small divergent angle.

### CROSS-REFERENCE TO RELATED APPLICATION

This application is based on and claims priority from Korean Patent Application No. 10-2014-0078431, filed on Jun. 25, 2014, with the Korean Intellectual Property Office, the disclosure of which is incorporated herein in its entirety by reference.

### BACKGROUND

1. Field

The present invention relates to an image technology, and more particularly, to an apparatus and a method of obtaining an image.

2. Discussion of Related Art

In general, an image obtaining apparatus may be divided in a passive apparatus and an active apparatus. The passive image obtaining apparatus receives light reflected from an object or generated by an object itself without a transmitted light source, collects the received light with a light receiving optical system, and then obtains an image by a detector or a detector array. The active image obtaining device transmits a wavelength with a predetermined band by a transmitter, detects a signal according to reflection of the transmitted light source from an object by a receiver, obtains the detected signal as an image signal, and makes the obtained image signal into an image.

Efforts to secure a wider viewing angle in the image obtaining apparatus have been exerted. The passive image obtaining apparatus needs to increase the number of detector arrays or a light receiving area of the detector in order to secure an image with a wider viewing angle. By contrast, in the active image obtaining apparatus, a light receiving unit needs to detect a light viewing angle, and a transmission light source part needs to light at a wide angle.

An example thereof includes a laser radar capable of obtaining a 3D image. The laser radar for obtaining a 3D image may include a pulse or frequency modulation light source, a transmission optical system, a reception optical system, an optical detector module, and a signal processor. A pulse output from a light source is transmitted as a collimated beam, which may be scanned, or with a predetermined divergent angle to an object that is a measurement target. Laser transmitted with a predetermined divergent angle is transmitted to a wide area and reflected from an object. A reflected signal is collected by the reception optical system, is converted into an electric signal by an optical detector array, and then is signal-processed for obtaining an image. That is, each pixel of the optical detector array measure a pulse flight time of a reflected signal of one pulse transmitted from the transmitted pulse light source with a predetermined divergent angle to obtain a 3D image.

In this case, a measurable region may be determined by a measurement distance, and sizes of the reception optical system and the optical detector array. In order to measure a wide area, a wide optical detector array and an appropriate reception optical system are demanded. In this case, a size of the optical detector array determines an entire measurement region, and a size of one pixel determines spatial resolution. The wide optical detector array may measure a region at 180° or more. In this case, the measurement region is limited by the optical detector.

Another method of measuring a 3D image is to rotate the entire modules by using a motor by configuring pulse light sources and light detectors, which make pairs, into a module disposed in the form of a vertical array. In this case, the entire directions may be measured based on one axis, but a measurable direction is determined by the number of pairs of the sensors based on the other axis. In the aforementioned method, in order to radiate the entire directions, the entire modules disposed in the array form need to be rotated by using the motor. When a 2D detector array usable in a passive image sensor is used, there is a limit in increasing a size (the number of pixels) of the optical detector array in order to secure a wider image while maintaining resolution. Accordingly, in order to wide a viewing angle without rotating a system, a different method from that in the related art is demanded.

### SUMMARY

The present invention has been made in an effort to provide an image obtaining apparatus capable of widening a viewing angle and maintaining high resolution without rotating a system.

An exemplary embodiment of the present invention provides an apparatus for obtaining an image, including: a light source configured to generate a laser pulse; a scanner configured to scan the laser pulse in a first direction; a first beam splitter configured to split the laser pulse irradiated in the first direction in the first direction and a second direction and irradiate the split laser pulse; and a light receiving unit configured to detect reflected light.

The first direction and the second direction may have an angle of 90°.

The light receiving unit may include: a first light detector configured to detect light reflected from the first direction; and a second light detector configured to detect light reflected from the second direction.

The apparatus may further include: a second beam splitter configured to split the laser pulse irradiated in the first direction in the first direction and a third direction and irradiate the split laser pulse; and a third beam splitter configured to split the laser pulse irradiated in the second direction in the second direction and a fourth direction and irradiate the split laser pulse, and, in which the light receiving unit may include: a first light detector configured to detect light reflected from the first direction; a second light detector configured to detect light reflected from the second direction; a third light detector configured to detect light reflected from the third direction; and a fourth light detector configured to detect light reflected from the fourth direction.

Another exemplary embodiment of the present invention provides an apparatus for obtaining an image, including: first and second light sources configured to generate laser pulses; a first scanner configured to irradiate the laser pulse generated by the first light source in a first direction; a second scanner configured to irradiate the laser pulse generated by the second light source in a second direction having an angle of 45° with the first direction; a first beam splitter configured to split light irradiated in the first direction in the first direction and a third direction; a second beam splitter configured to split light irradiated in the second direction in the second direction and a fourth direction; and a light receiving unit configured to receive reflected light.

The first and second light sources may generate pulses at different times.

The first scanner and the second scanner may be disposed at different positions in a vertical direction with respect to a ground.

Yet another exemplary embodiment of the present invention provides a method of obtaining an image, including: generating light by a light source; irradiating the generated light in a first direction; irradiating the generated light in a first direction; and detecting light reflected from the light irradiated in the first direction and the second direction, and converting the detected light into an electric signal.

The splitting of the light irradiated in the first direction in the first direction and the second direction may include making the first direction and the second direction have an angle of 90° by adjusting a reflective surface of the beam splitter to have an angle of 45° with the first direction.

The method may further include processing the converted electric signal and generating image data.

According to the present invention, it is possible to provide the image obtaining apparatus capable of widening a viewing angle and maintaining high resolution without rotating a system.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and advantages of the present invention will become more apparent to those of ordinary skill in the art by describing in detail embodiments thereof with reference to the attached drawings in which:

FIG. 1 is a diagram for describing light source emission when a general optical detector array is used;

FIG. 2 is a diagram for describing a form of scan irradiation of beam when a light source is irradiated by using a scanner;

FIG. 3 is a block diagram illustrating an image obtaining apparatus according to an exemplary embodiment of the present invention;

FIG. 4 is a diagram illustrating an irradiation form of light passing through a beam splitter when an angle of an incident light source is changed in an image obtaining apparatus according to an exemplary embodiment of the present invention;

FIG. 5 is a diagram illustrating an image obtaining apparatus capable of irradiating beam in four directions according to an exemplary embodiment of the present invention;

FIG. 6 is a diagram illustrating the image obtaining apparatus of FIG. 5 briefly; and

FIG. 7 is a diagram illustrating the case where the two image obtaining apparatuses of FIG. 6 are vertically disposed with respect to a ground to irradiate in the entire directions.

### DETAILED DESCRIPTION

Hereinafter, the present invention will be described in more detail with reference to drawings to which preferred examples according to the present invention are attached in order to describe the present invention more specifically. As those skilled in the art would realize, the described embodiments may be modified in various different ways, all without departing from the spirit or scope of the present invention.

Hereinafter, exemplary embodiments of the present invention will be described with reference to the accompanying drawings. The same reference numbers are used throughout the drawings to refer to the same or like parts. Detailed descriptions of well-known functions and structures incorporated herein may be omitted to avoid obscuring the subject matter of the present invention.

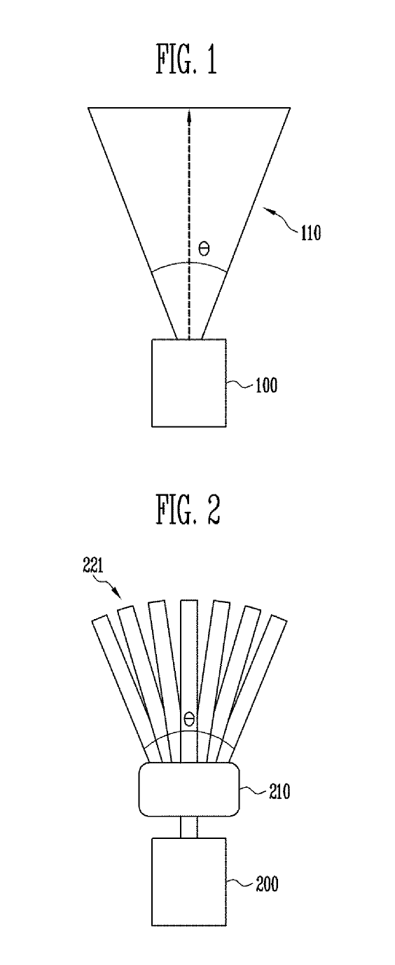

FIG. 1 is a diagram for describing light emitted from a light source when a general optical detector array is used.

A light source used in an image system has a different irradiation method according to a use form of the image system. Obtainment of an image by once irradiation may be present as FIG. 1. Referring to FIG. 1, a light source 100 irradiates light 110 within a range of a divergent angle (θ). The irradiated light 110 is reflected from a target object within a region, to which the light is irradiated, and is detected by a light reception unit. Although not illustrated in FIG. 1, in the exemplary embodiment, the light reception unit may be integrally formed with the light source 100. The light detected by the light reception unit may be converted into an electric signal and may be subjected to a signal processing process, so that image data may be generated. The light source of FIG. 1 cannot irradiate light to a wide region due to a limitation of the divergent angle (θ).

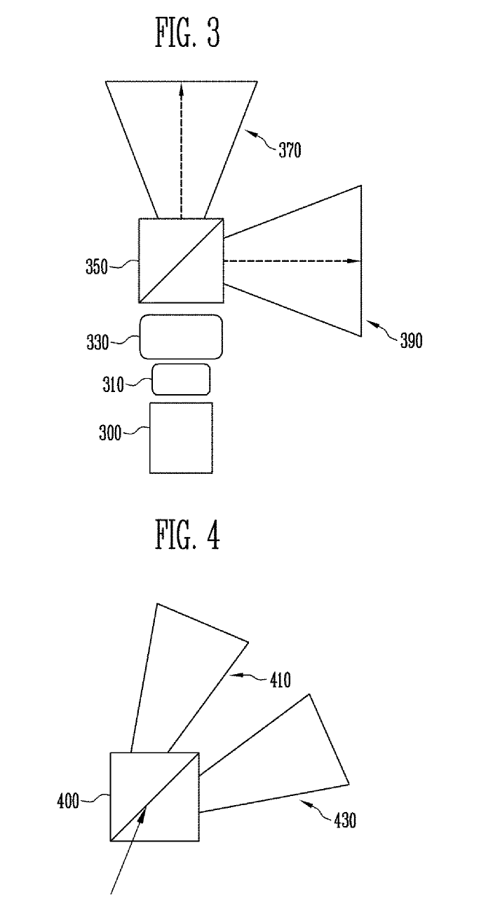

FIG. 2 is a diagram for describing a form of scan irradiation of beam when a light source is irradiated by using a scanner.

Referring to FIG. 2, light generated by a light source 200 is converted into a plurality of parallel beams 221 through a scanner 210 to be irradiated. In FIG. 2, the plurality of parallel beams 221 is irradiated within a range of a divergent angle (θ), but is not irradiated to a wide region due to a limitation in a driving angle of the scanner.

As described above, in FIGS. 1 and 2, the beams are not irradiated to the wide region or the entire regions due to the limitation in a divergent angle or the driving angle of the scanner.

FIG. 3 is a block diagram illustrating an image obtaining apparatus according to an exemplary embodiment of the present invention.

Referring to FIG. 3, an image obtaining apparatus according to an exemplary embodiment of the present invention includes a light source 300, a scanner 310, and a beam splitter 350. According to an exemplary embodiment of the present invention, the image obtaining apparatus may further include an optical lens 330.

The light source 300 may generate a laser pulse. The image obtaining apparatus according to the exemplary embodiment of the present invention may generate a laser pulse, and receive reflected light of beam generated by the pulse through a light reception unit in order to obtain a still image. In another exemplary embodiment, the light source may generate light in the form of continuous light, not the pulse form.

The scanner 310 may irradiate the laser pulse generated by the light source 300 in a specific direction. The light irradiated by the scanner 310 may be irradiated within a range of a predetermined divergent angle. In order to overcome a limit of the divergent angle, the image obtaining apparatus according to the exemplary embodiment of the present invention may include the beam splitter 350 to increase a light irradiation range.

The optical lens 330 refracts the light emitted from the scanner 310 to increase a divergent angle. As described with reference to FIGS. 1 and 2, there is a limit in increasing a divergent angle for the light irradiation range simply through the optical lens, so that the image obtaining apparatus according to the exemplary embodiment of the present invention increases the light irradiation range by adopting the beam splitter.

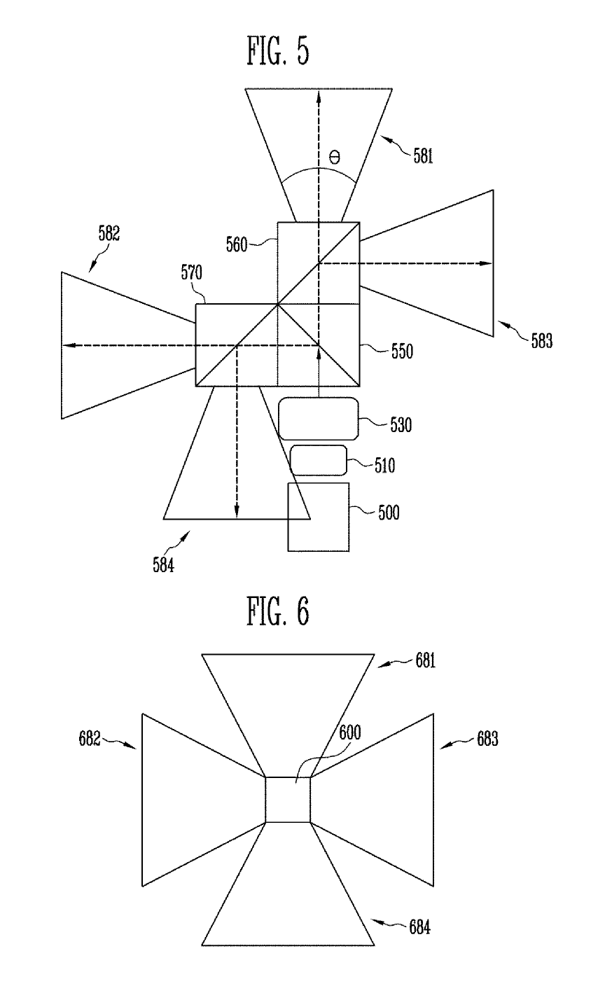

The beam emitted from the light source is divided in two directions by the beam splitter 350 through the optical lens for increasing the divergent angle. In the exemplary embodiment of FIG. 3, the light incident to the beam splitter 350 is incident at an angle of 45° with respect to a reflective surface of the beam splitter 350. In this case, light 370 passing through the reflective surface moves in an original direction, that is, a first direction, and light 390 reflected from the reflective surface moves in a second direction that is perpendicular to the first direction. Accordingly, the light emitted from the light source has two times of irradiation ranges through the beam splitter 350. According to the exemplary embodiment, the light incident to the beam splitter may not have an angle of 45° with respect to the reflective surface. The exemplary embodiment will be described below with reference to FIG. 4.

Although not illustrated in FIG. 3, an image obtaining apparatus according to an exemplary embodiment of the present invention may include a light reception unit for receiving the reflected light. In the exemplary embodiment of FIG. 3, the light reception unit may include a first light detector for detecting the light 370, which passes through the reflective surface of the beam splitter 350, reflected from a target object and returned, and a second light detector for detecting the light 390, which is reflected from the reflective surface of the beam splitter 350, reflected from a target object and returned. Further, the light receiving unit may process electric signals detected by the first light detector and the second detector and generate the processed electric signals into an image. The generated image may include all of an image indicating a region to which the light 370 passing through the reflective surface of the beam splitter 350 is irradiated, and an image indicating a region to which the light 390 reflected from the reflective surface of the beam splitter 350 is irradiated. Accordingly, even though there is a limit in an irradiation angle of the single scanner, the image obtaining apparatus according to the exemplary embodiment of the present invention may obtain an image with a wider region by using the beam splitter.

FIG. 4 is a diagram illustrating an irradiation form of light passing through a beam splitter when an angle of an incident light source is changed in the image obtaining apparatus according to the exemplary embodiment of the present invention.

Referring to FIG. 4, in the image obtaining apparatus according to the exemplary embodiment of the present invention, light incident to a beam splitter 400 may not have an angle of 45° with respect to a reflective surface. FIG. 4 illustrates the case where incident light (see an arrow) moves at a larger incident angle than 45° with respect to the reflective surface of the beam splitter 400. In this case, light 410 passing through the reflective surface is changed in a moving direction by refraction on the reflective surface, and light 430 reflected from the reflective surface has an incident angle larger than 45°, so that the light 430 is irradiated while having an angle smaller than 90° with the light 410 passing through the reflective surface. In comparison between the exemplary embodiment of FIG. 3 and the exemplary embodiment of FIG. 4, a wide blind spot is formed between the light 370 passing through the reflective surface and the light 390 reflected from the reflective surface in the exemplary embodiment of FIG. 3, but a relatively small blind spot is formed between the light 410 passing through the reflective surface and the light 430 reflected from the reflective surface in the exemplary embodiment of FIG. 4 under the same condition. Accordingly, it is possible to adjust an angle of the beam splitter according to an irradiation angle of light irradiated through the scanner. For example, when the light irradiated through the scanner has a relatively large irradiation angle, it is possible to increase an irradiation range by adjusting an angle of the beam splitter so that an incident angle of the light incident to the reflective surface of the beam splitter is close to 45°. In the meantime, when the light irradiated through the scanner has a relatively small irradiation angle, it is possible to minimize a blind spot between the light passing through the reflective surface and the light reflected from the reflective surface by adjusting an incident angle of the light incident to the reflective surface of the beam splitter to be larger than 45°.

FIG. 5 is a diagram illustrating an image obtaining apparatus capable of irradiating beam in four directions according to an exemplary embodiment of the present invention.

Referring to FIG. 5, an image obtaining apparatus according to an exemplary embodiment of the present invention includes a light source 500, a scanner 510, a first beam splitter 550, a second beam splitter 560, and a third beam splitter 570. According to an exemplary embodiment of the present invention, the image obtaining apparatus may further include an optical lens 530. Configurations and functions of the light sources 500, the scanner 510, and the optical lens 530 have been described with reference to FIG. 3, so that descriptions thereof will be omitted so as to avoid overlapping of thereof.

Light passing through the optical lens 530 is incident to the first beam splitter 550. The first beam splitter may split the incident light in a first direction and a second direction. In FIG. 5, the first direction is an original direction of the light passing through the optical lens 530, and the light split the first direction is incident to the second beam splitter 560. The second direction is a direction in which the light is reflected from a reflective surface of the first beam splitter 550, and the light split in the second direction is incident to the third beam splitter 570.

The image obtaining apparatus of FIG. 5 is different from the image obtaining apparatus of FIG. 3 in that a light irradiation range and a cover range of an obtained image are increased by further adopting the additional two beam splitters. The light split in two directions by the first beam splitter 550 is divided into two directions again while passing through the second and third beam splitters 560 and 570, to be irradiated in a total of four directions.

That is, the second beam splitter 560 may split the light passing through the reflective surface of the first beam splitter 560 in the first direction and the third direction. In FIG. 5, the first direction is a direction of the light passing through the optical lens 530, and the light split in the first direction is light 581 passing through all of the reflective surfaces of the first beam splitter 550 and the second beam splitter 560. The third direction is a direction in which the light is reflected from the reflective surfaces of the second beam splitter 560, and light 583 split in the third direction has an angle of about 90° with the light 581 split in the first direction. The third beam splitter 570 may split the light reflected from the reflective surface of the first beam splitter 550 in the second direction and a fourth direction. In FIG. 5, the second direction is a direction of light 582 reflected from the reflective surface of the first beam splitter 550 and passing through the reflective surface of the third beam splitter 570. The fourth direction is a direction of light 584 reflected from the reflective surface of the first beam splitter 550 and reflected from the reflective surface of the third beam splitter 570. The light 581 in the first direction, the light 582 in the second direction, the light 583 in the third direction, and the light 584 in the fourth direction may have an angle of 90° with each other, and may be irradiated to a region corresponding to a total of four times of a region of a divergent angle (θ) of the single beam. In the exemplary embodiment of FIG. 5, it is illustrated the case where each divergent angle (θ) is smaller than 90°, and in this case, blind spots are generated between the light 581, 582, 583, and 584 finally passing through the beam splitter. When each divergent angle (θ) is equal to or larger than 90°, the light passing through the first to third beam splitters may be irradiated in the whole direction at 360°. According to the related art, a total of four same light sources is required when an irradiation angle of a single light source is 90° in order to irradiate light in a whole direction, but the image obtaining apparatus according to the exemplary embodiment of the present invention may irradiate light in a whole direction by using one light source and three beam splitters.

Although not illustrated in FIG. 5, the image obtaining apparatus according to the exemplary embodiment of the present invention may include a light reception unit for receiving the reflected light. In the exemplary embodiment of FIG. 5, the light receiving unit may include a first light detector for detecting the first directional light 581 reflected from a target object and returned, a second light detector for detecting the second directional light 582 reflected from a target object and returned, a third light detector for detecting the third directional light 583 reflected from a target object and returned, and a fourth light detector for detecting the fourth directional light 584 reflected from a target object and returned. Further, the light receiving unit may process electric signals detected by the first to fourth light detectors and generate the processed electric signals into an image. The generated image may include all of images indicating regions to which the light 581 and the light 583 passing through the reflective surface of the beam splitter 550 is irradiated, and images indicating regions to which the light 582 and the light 584 reflected from the reflective surface of the beam splitter 550 is irradiated. Accordingly, even though there is a limit in an irradiation angle of the single scanner, the image obtaining apparatus according to the exemplary embodiment of the present invention may obtain an image with a wider region by using the beam splitter.

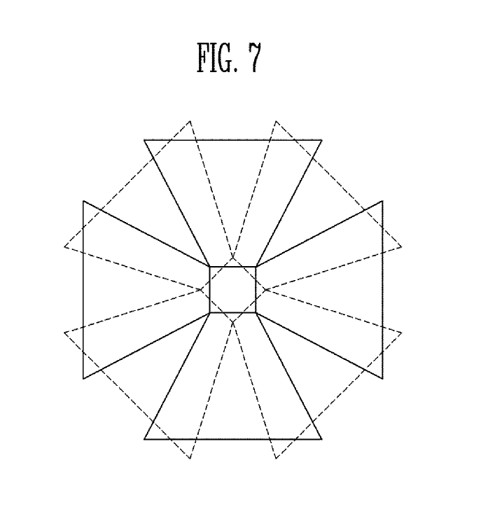

According to the exemplary embodiment of FIG. 5, when each divergent angle (θ) is smaller than 90°, blind spots are generated between the light 581, 582, 583, and 584 finally passing through the beam splitter. FIG. 6 illustrates the image obtaining apparatus according to the exemplary embodiment of FIG. 5 briefly.

FIG. 6 is a diagram illustrating the image obtaining apparatus of FIG. 5 briefly.

Referring to FIG. 6, it is illustrated light 681, 62, 63, and 684 irradiated in four directions through an image obtaining apparatus 600 of FIG. 5. As illustrated in FIG. 6, when a divergent angle of the light irradiated through the image obtaining apparatus 600 is smaller than 90°, a blind spot is generated between light. In order to supplement the generated blind spot, the two image obtaining devices may be disposed to be vertical a ground as illustrated in FIG. 7.

FIG. 7 is a diagram illustrating the case where the two image obtaining apparatuses of FIG. 6 are vertically disposed with respect to a ground to irradiate in the entire directions.

Referring to FIG. 7, the image obtaining apparatuses are vertically disposed with an angle difference of about 45°. FIG. 7 is a top plan view of the image obtaining apparatuses in a direction of a ground, and thus the image obtaining apparatus disposed in a lower side is illustrated by a dotted line, and the image obtaining apparatus disposed in an upper side is illustrated by a solid line. As illustrated in FIG. 7, when a divergent angle of light irradiated in four directions from each of the image obtaining apparatuses is smaller than 90°, it is possible to prevent a blind spot, and irradiate light in the entire directions by disposing the two image obtaining apparatuses with an angle of about 45°. In this case, the two image obtaining apparatuses may be operated with a time difference. For example, light sources included in the two image obtaining apparatuses may generate pulses at different times. In the above description, an example in which the two image obtaining apparatuses of FIG. 6 are operated has been explained, but the image obtaining apparatus of FIG. 6 may be implemented as one module, and the two modules may be implemented as one image obtaining apparatus disposed as illustrated in FIG. 7. In this case, the image obtaining apparatus may include a first module and a second module. The first module may include a first light source, a first scanner, and three beam splitters. Further, the second module may include a second light source, a second scanner, and three beam splitters. Each of the first module and the second module may include a light receiving unit, and the light receiving unit independently configured from the first module and the second module may be included in the image obtaining apparatus. Further, light detected by the light receiving unit may be converted into an electric signal to generate image data.

As described above, the embodiment has been disclosed in the drawings and the specification. The specific terms used herein are for purposes of illustration, and do not limit the scope of the present invention defined in the claims. Accordingly, those skilled in the art will appreciate that various modifications and another equivalent example may be made without departing from the scope and spirit of the present disclosure. Therefore, the sole technical protection scope of the present invention will be defined by the technical spirit of the accompanying claims.

What is claimed is:

1. An apparatus for obtaining an image, comprising:
a light source configured to generate a laser pulse;
a scanner configured to irradiate the laser pulse in a first direction;
a first beam splitter configured to split the laser pulse irradiated in the first direction in the first direction and a second direction and irradiate the split laser pulse; and
a light receiving unit configured to detect reflected light.

2. The apparatus of claim 1, wherein the first direction and the second direction have an angle of 90°.

3. The apparatus of claim 1, wherein the light receiving unit includes:
a first light detector configured to detect light reflected from the first direction; and
a second light detector configured to detect light reflected from the second direction.

4. The apparatus of claim 1, further comprising:
a second beam splitter configured to split the laser pulse irradiated in the first direction in the first direction and a third direction and irradiate the split laser pulse; and
a third beam splitter configured to split the laser pulse irradiated in the second direction in the second direction and a fourth direction and irradiate the split laser pulse, and
wherein the light receiving unit includes:
a first light detector configured to detect light reflected from the first direction;
a second light detector configured to detect light reflected from the second direction;
a third light detector configured to detect light reflected from the third direction; and
a fourth light detector configured to detect light reflected from the fourth direction.

5. An apparatus for obtaining an image, comprising:
first and second light sources configured to generate laser pulses;
a first scanner configured to irradiate the laser pulse generated by the first light source in a first direction;
a second scanner configured to irradiate the laser pulse generated by the second light source in a second direction having an angle of 45° with the first direction;
a first beam splitter configured to split light irradiated in the first direction in the first direction and a third direction;
a second beam splitter configured to split light irradiated in the second direction in the second direction and a fourth direction; and
a light receiving unit configured to receive reflected light.

6. The apparatus of claim 5, wherein the first and second light sources generate pulses at different times.

7. The apparatus of claim 5, wherein the first scanner and the second scanner are disposed at different positions in a vertical direction with respect to a ground.

8. A method of obtaining an image, comprising:
generating light by a light source;
irradiating the generated light in a first direction;
splitting the light irradiated in the first direction in the first direction and a second direction by using a beam splitter; and
detecting light reflected from the light irradiated in the first direction and the second direction, and converting the detected light into an electric signal.

9. The method of claim 8, wherein the splitting of the light irradiated in the first direction in the first direction and the second direction includes making the first direction and the second direction have an angle of 90° by adjusting a reflective surface of the beam splitter to have an angle of 45° with the first direction.

10. The method of claim 8, further comprising:
processing the converted electric signal and generating image data.
